(19) United States
(12) Patent Application Publication
(10) Pub. No.: US 2006/0145957 A1
(43) Pub. Date: Jul. 6, 2006

(54) Plasma display device and method of driving the same

(76) Inventors: Yang Hyun Kim, Busan (KR); Min Seok Choi, Masan-si (KR)

Correspondence Address: MCKENNA LONG & ALDRIDGE LLP;Song K. Jung, 1900 K Street, N.W., Washington, DC, 20006, US

(21) Appl. No.: 11/304,573

(22) Filed: Dec. 16, 2005

(30) Foreign Application Priority Data
Dec. 31, 2004 (KR) P2004-118591

(51) Int. Cl. G09G 3/28

(52) U.S. Cl. 345/67

(57) ABSTRACT

The present invention relates to a plasma display device and a method of driving the same, where the device and the method minimize the problem of image sticking. The device and method involve applying a first sustain pulse to a first electrode and a applying a second sustain pulse to a second electrode, during a sustain period of at least one subfield, wherein the second sustain pulse includes a rising voltage interval and the first sustain pulse includes a falling voltage interval such that the rising and falling voltage intervals at least partially overlap each other.

This application claims the benefit of Korean Patent Application No. P2004-118591 filed Dec. 31, 2004, which is hereby incorporated by reference.

### BACKGROUND OF THE INVENTION

1. Field of the Invention

The present invention relates to a plasma display panel, and more particularly, to a plasma display device and a method of driving the same that is capable of minimizing image sticking.

2. Description of the Related Art

Generally, a plasma display panel (PDP) excites and radiates a phosphorus material using an ultraviolet ray generated upon discharge of an inactive gas mixture such as He+Xe, Ne+Xe or He+Ne+Xe, to thereby display a picture. Such a PDP is easily made into a thin-film, large-dimension type display. Moreover, the PDP provides improved picture quality owing to recent technical developments.

Referring to FIG. 1, a discharge cell of a related art three-electrode, alternating current (AC) surface-discharge PDP includes a scan electrode Y and a sustain electrode Z provided on an upper substrate 16, and an address electrode X provided on a lower substrate 14.

Both the scan electrode Y and the sustain electrode Z include a transparent electrode and a metal bus electrode having a smaller width than the transparent electrode and provided at one edge of the transparent electrode. The transparent electrode is usually formed from indium-tin-oxide (ITO) on the upper substrate 16. The metal bus electrode is usually formed from a metal such as chrome (Cr) or the like on the transparent electrode, to thereby reduce voltage drops caused by the transparent electrode, which has a high resistance.

On the upper substrate 16 provided, in parallel, with the scan electrode Y and the sustain electrode Z, an upper dielectric layer 12 and a protective film 10 are disposed. Wall charges generated upon plasma discharge are accumulated on the upper dielectric layer 12. The protective film 10 prevents damage to the upper dielectric layer 12 caused by sputtering during the plasma discharge and improves the emission efficiency of secondary electrons. This protective film 10 is usually made from magnesium oxide (MgO).

A lower dielectric layer 18 and barrier ribs 8 are formed on a lower substrate 14, which includes the address electrode X. The surfaces of the lower dielectric layer 18 and the barrier ribs 8 are coated with a phosphorous material 6. The address electrode X is formed in a direction that is perpendicular to the scan electrode Y and the sustain electrode Z. The barrier rib 8 is formed in parallel to the address electrode X to thereby prevent ultraviolet rays and visible light generated by a discharge from leaking into adjacent discharge cells. The phosphorous material 6 is excited by an ultraviolet ray generated during the plasma discharge to generate any one of red, green and blue visible light rays. An inactive gas mixture for a gas discharge is injected into a discharge space between the upper and lower substrate 16 and 14 and the barrier rib 6.

In such a PDP, each image frame is divided into sub-fields, each having a different emission frequency, so as to realize different gray levels of a picture. Each sub-field is divided into a reset period for initializing the entire field, an address period for selecting an address electrode and selecting certain cells along the selected address electrode, and a sustain period for expressing gray levels depending on the discharge frequency. Herein, the reset period is divided into a set-up interval supplied with a rising ramp waveform and a set-down interval supplied with a falling ramp waveform.

For instance, when it is intended to display a picture of 256 gray levels, a frame interval equal to 1/60 second of a (i.e. 16.67 msec) is divided into 8 sub-fields SF1 to SF8. Each of the 8 sub-field SF1 to SF8 is divided into a reset period, an address period and a sustain period as mentioned above. Herein, the reset period and the address period of each sub-field are the same for each sub-field, however, the sustain period is increased at a ratio of 2ⁿ (wherein n=0, 1, 2, 3, 4, 5, 6 and 7) at each sub-field.

FIG. 2 shows a driving waveform of the PDP applied during one sub-field.

Herein, Y represents the scan electrode; Z represents the sustain electrode; and X represents the address electrode.

Referring to FIG. 2, the PDP is divided into a rest period RPD for initializing the full field, an address period APD for selecting certain discharge cells, and a sustain period SPD for sustaining a discharge for the selected discharge cells.

During the reset period RPD, a reset pulse RP is applied to the scan electrode Y. The reset pulse RP has an increasing voltage ramp waveform during a set-up interval and a decreasing voltage ramp waveform during a set-down interval. During the set-up interval, a reset discharge is generated between the scan electrode Y and the sustain electrode Z to cause a weak discharge within all cells, to thereby generate wall charges within the cells. Sequentially, spurious charges are partially erased by the voltage decrease in the set-down interval, so that the wall charges do not cause a miss discharge and are decreased as much as required for an address discharge. To decrease these wall charges, a direct current voltage Vs of a positive polarity (+) is applied to the sustain electrode Z in the set-down interval of the reset pulse RP. Since the reset pulse RP corresponding to the direct current voltage Vs of the positive polarity (+) is decreased and applied gradually, the scan electrode Y has a negative polarity (−) in opposition to the sustain electrode Z in the set-down interval. In other words, polarity is inversed, to thereby decrease the wall charges generated during the set-up interval. As mentioned above, the reset discharge is generated by supplying the reset pulse RP and the wall charges required for the address discharge are formed identically within all the cells of the full field.

In the address period APD, a scanning pulse SP is applied to the scan electrode Y and, at the same time, a data pulse is applied to the address electrode X, to thereby generate an address discharge. Wall charges formed by the address discharge are maintained while other discharge cells are addressed.

In the sustain period SPD, after a sustain pulse SUSPY having a sustain voltage is applied to the scan electrode Y, sustain pulses SUSPY and SUSPZ are alternatively applied to the sustain electrode Z and the scan electrode Y without overlapping each other. The pulse width of both the sustain pulse SUSPY applied to the scan electrode Y and the sustain pulse SUSPZ applied to the sustain electrode Z is about 100 ns to 200 ns. Accordingly, a wall voltage within the cell selected during the address discharge is added to the sustain voltage Vsus to thereby generate a sustain discharge, that is, a display discharge, between the scan electrodes Y and the sustain electrode Z whenever sustain pulses SUSPY and SUSPZ are applied.

On the other hand, the sustain discharge does not occur in non-selected cells that are not selected in the address period because the sum of the wall voltage within the non-selected cells and an external voltage is lower than the firing voltage during the sustain period SPD. After the completion of the sustain discharge, an erasing signal (not shown) for erasing the wall charge remaining within the cells is applied to the scan electrode Y or the sustain electrode Z.

However, the afore mentioned PDP has a problem in that bright image sticking occurs when a bright image is displayed during more than a certain amount of time, even though the display is then changed into a dark image. The reason for this is that charges accumulated within cells, as a result of the sustain discharge, generated during the sustain period, migrate to adjacent discharge cells, where they accumulate on the phosphorous material. Further, the related art PDP generates a weak discharge when the rising time of a sustain pulse is fast. As a result, driving margin is lowered, thereby resulting in a miss discharge at higher temperatures.

### SUMMARY OF THE INVENTION

Accordingly, it is an object of the present invention to provide a plasma display device and a method of driving the same that minimizes image sticking and reduces power consumption.

In accordance with a first aspect of the present invention, the above-identified and other objects are achieved by a plasma display device that includes a first driver and a second driver. The first driver is configured such that it applies a first sustain pulse to a first electrode and the second driver is configured such that it applies a second sustain pulse to a second electrode. The second sustain pulse includes a rising voltage interval and the first sustain pulse includes a falling voltage interval, where the rising voltage interval and the falling voltage interval at least partially overlap.

In accordance with a second aspect of the present invention, the above-identified and other objects are achieved by a plasma display device that includes a first driver and a second driver. The first driver is configured such that it applies a first sustain pulse to a first electrode and the second driver is configured such that it applies a second sustain pulse to a second electrode. In addition, the duty cycle of the first sustain pulse and the duty cycle of the second sustain pulse have a range of about 50% to 67%, such that a rising voltage interval associated with the first sustain pulse overlaps a falling voltage interval associated with the second sustain pulse during at least a portion of a voltage variation interval.

In accordance with a third aspect of the present invention, the above-identified and other objects are achieved by a method of driving a plasma display device. The method involves applying a first sustain pulse to a first electrode and applying a second sustain pulse to a second electrode, where the second sustain pulse includes a rising voltage interval and the first sustain pulse includes a falling voltage interval, and where the rising voltage interval and the falling voltage interval at least partially overlap.

### BRIEF DESCRIPTION OF THE DRAWINGS

These and other objects of the invention will be apparent from the following detailed description of the embodiments of the present invention with reference to the accompanying drawings, in which:

FIG. 1 is a perspective view showing a related art AC surface-discharge plasma display panel;

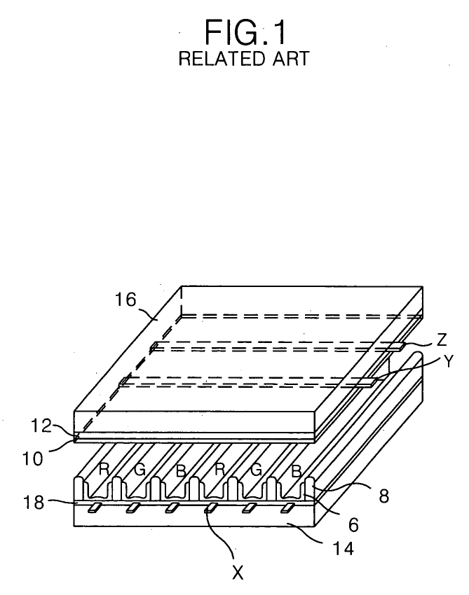

FIG. 2 is a diagram of a driving waveform for the PDP in FIG. 1;

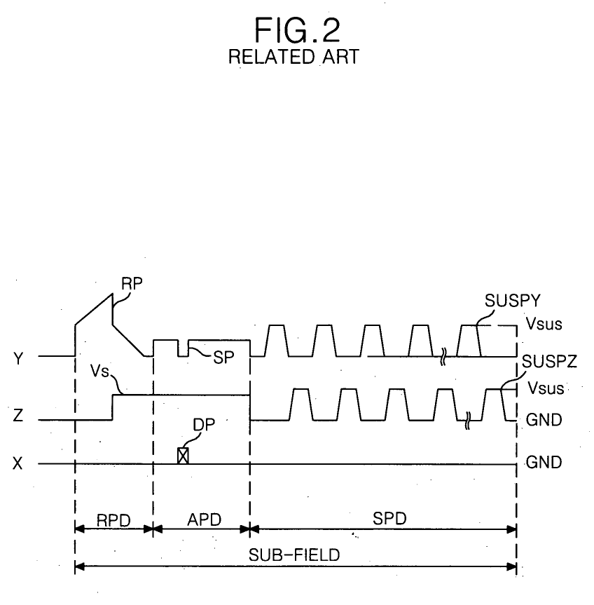

FIG. 3 is a diagram of a driving waveform for a PDP according to exemplary embodiments of the present invention;

FIG. 4 is a diagram of a waveform illustrating a minimum overlapping interval of both the sustain pulses shown in FIG. 3; and

FIG. 5 is a diagram of a waveform illustrating a maximum overlapping interval of both the sustain pulses shown in FIG. 3.

### DETAILED DESCRIPTION OF THE PREFERRED EMBODIMENT

Reference will now be made in detail to the preferred embodiments of the present invention, examples of which are illustrated in the accompanying drawings.

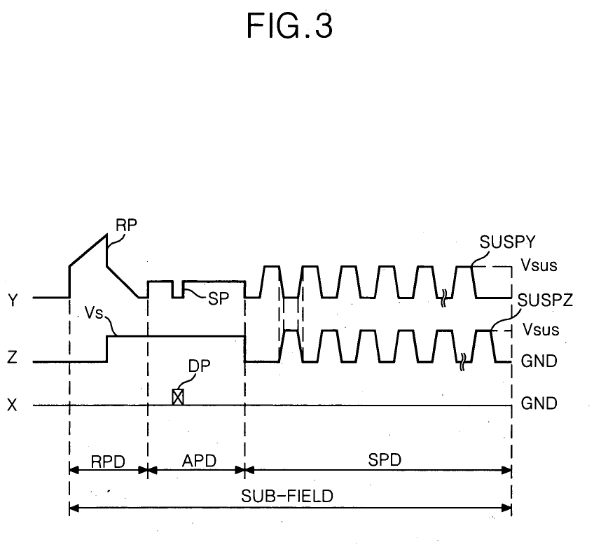

Hereinafter, the preferred embodiments of the present invention will be described in detail with reference to FIGS. 3 to 5.

Referring to FIG. 3, a driving method of a plasma display device according to an exemplary embodiment of the present invention is divided into: a reset period RPD applying a reset pulse RP to a scan electrode Y during each sub-field of a given frame, thereby generating a reset discharge and initializing a discharge cell in order to display a designated image; an address period APD for supplying a data pulse to an address electrode X and, at the same time, applying a scanning pulse SP to the scan electrode Y to generate an address discharge and to select the discharge cell; and a sustain period SPD where a sustain pulse SUSPY applied to the scan electrode Y overlaps a sustain pulse SUSPZ applied to the sustain electrode Z during at least a 10 ns interval in order to generate a sustain discharge between the scan electrode Y and the sustain electrode Z, and to thereby maintain the discharge selected during the address period APD.

In the reset period RPD, a reset pulse RP is applied to the scan electrode Y. The reset pulse RP is characterized by an increasing voltage in the form of a positive ramp waveform during a set-up interval, and characterized by a decreasing voltage in the form of a negative ramp waveform during a set-down interval. In the set-up interval, a reset discharge is generated between the scan electrode Y and the sustain electrode Z so as to cause a weak discharge within all of the cells, and to thereby generate wall charges within the cells. Sequentially, spurious charges are partially erased by the voltage decrease during the set-down interval, so that the wall charges do not cause a miss discharge and are decreased as required for an address discharge. To decrease these wall charges, a direct current voltage Vs of a positive polarity (+) is applied to the sustain electrode Z during the set-down interval of the reset pulse. Since the reset pulse RP corresponding to the direct current voltage Vs of the positive polarity (+) is gradually applied, the scan electrode Y has a negative polarity (−) in opposition to the sustain electrode Z during the set-down interval. In other words, the polarity is inversed, to thereby decrease the wall charges generated during the set-up interval. As mentioned above, the reset discharge is generated as a result of the reset pulse RP and the wall charges required for the address discharge are formed identically within all of the cells.

During the address period APD, a scanning pulse SP is applied to the scan electrode Y and, at the same time, a data pulse is applied to the address electrode X, to thereby generate an address discharge. Wall charges formed by the address discharge are maintained while other discharge cells are addressed.

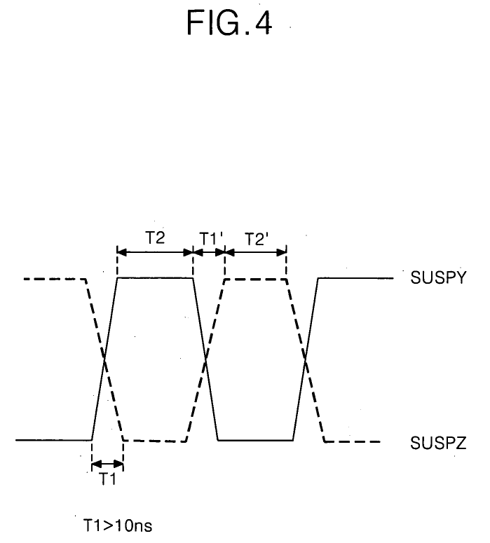

During the sustain period SPD, sustain pulses SUSPY and sustain pulses SUSPZ having a sustain voltage Vsus are alternatively applied to the scan electrode Y, wherein the pulses partially overlap during voltage variation intervals T1 and T1′ as illustrated, for example, in FIG. 4.

The sustain pulse SUSPY applied to the scan electrode Y includes: a rising edge voltage interval of about 300 ns to 700 ns; a voltage maintaining interval T2 of about 1.7 μs to 1.9 μs; and a falling edge voltage interval of about 300 ns to 600 ns. The rising edge voltage interval of the sustain pulse SUSPY rises from a ground voltage GND to the sustain voltage Vsus. The voltage level during the maintaining interval T2 is the sustain voltage Vsus, and the falling edge voltage interval falls from the sustain voltage Vsus to the ground voltage GND.

Further, the sustain pulse SUSPZ applied to the sustain electrode Z includes: a rising edge voltage interval of about 300 ns to 700 ns; a voltage maintaining interval T2′ of about 1.1 μs to 1.3 μs; and a falling edge voltage interval of about 300 ns to 600 ns. The duration of the voltage maintaining interval T2′ associated with the sustain pulse SUSPY is shorter than the voltage maintaining interval T2 that is associated with the first sustain pulse SUSPY.

Meanwhile, if the rising edge voltage intervals of the sustain pulses SUSPY and SUSPZ become long, for example, in the range of in 300 ns to 700 ns, then a double discharge may occur. This would improve discharge efficiency and light emission efficiency. Since the brightness of the discharge cell becomes high, image sticking is minimized. Further, as mentioned below, when the voltage variation intervals of the first sustain pulse SUSPY and the sustain pulse SUSPZ partially overlap, space charges are sufficiently used upon a discharge, even a relatively weak discharge. Accordingly, driving margin is secured and power consumption is reduced.

The sustain pulse SUSPY and the sustain pulse SUSPZ, as shown in FIG. 4, partially overlap during the voltage variation intervals T1 and T1′, where T1 and T1′ are in the range of about 10 ns to 500 ns. In other words, the sustain pulses SUSPY and the SUSPZ are alternatively applied to the scan electrode Y and the sustain electrode Z, respectively, so that the falling edge of the sustain pulse SUSPY and the rising edge of the sustain pulse SUSPZ partially overlap during the voltage variation interval T1, and where the rising edge of the sustain pulse SUSPY and the falling edge of the sustain pulse SUSPZ partially overlap during the voltage variation interval T1′. Again, T1 and T1′ are in the range of about 10 ns to 500 ns. In this embodiment, the rising edge voltage interval of the sustain pulse SUSPY can only overlap the falling edge voltage interval of the sustain pulse SUSPZ, and the falling edge voltage interval of the sustain pulse SUSPY can only overlap the rising edge voltage interval of the sustain pulse SUSPZ.

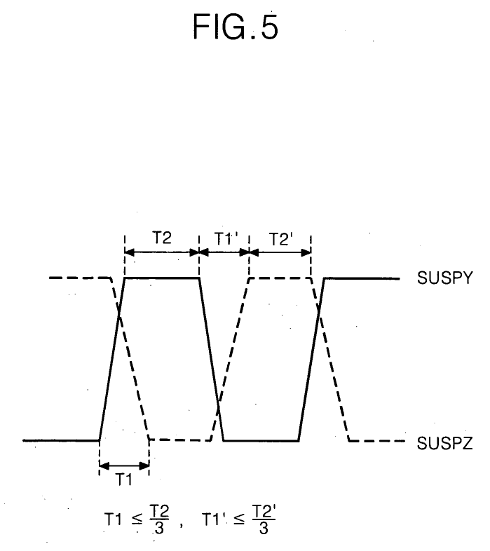

In another exemplary embodiment, the sustain pulses SUSPY and SUSPZ, as shown in FIG. 5, overlap during voltage variation intervals T1 and T1′, where the maximum duration of voltage variation intervals T1 and T1′ is one-third (⅓) the duration of maintaining intervals T2 and T2′, respectively. Again, the voltage associated with maintaining intervals T2 and T2′ is Vsus. In order to satisfy the above overlap condition, a duty ratio of the sustain pulses is in the range of 50% to about 67%.

If the voltage variation intervals T1 and T1′ increase more than ⅓ the duration of maintain intervals T2 and T2′, respectively, electromagnetic interference and discharge cell temperature increase, and distortion of the sustain pulse can occur.

A wall voltage in a cell selected during the address period APD is added to the sustain voltage Vsus to thereby generate a sustain discharge, that is, a display discharge, between the scan electrodes Y and the sustain electrode Z whenever the sustain pulses SUSPY and SUSPZ are applied. During the sustain period SPD, the duty cycle associated with both the sustain pulse SUSPY and the sustain pulse SUSPZ is effectively increased, thereby decreasing the discharge delay time of the sustain discharge. This, in turn, reduces image sticking, caused by discharge delay, and reduces power consumption. Preferably, the duty cycle would be in the range of 50% to about 67%.

On the other hand, the sustain discharge does not occur in cells not selected during the address period APD, because the sum of the wall voltage within the non-selected cells and an external voltage is lower than the firing voltage, during the sustain period SPD.

After the completion of the sustain discharge, an erasing signal (not shown) for erasing the wall charge remaining within the cells is applied to the scan electrode Y or the sustain electrode Z.

As mentioned above, the driving method of the plasma display device according to an exemplary embodiment of the present invention involves overlapping the sustain pulse SUSPY applied to the scan electrode Y with the sustain pulse SUSPZ applied to the sustain electrode Z during the voltage variation intervals T1 and T1′ to generate the sustain discharge, and to thereby minimize discharge delay of the sustain discharge. Thus, it is possible to minimize image sticking caused when a specific picture is implemented during a definite time. Accordingly, the driving method of the plasma display device according to the present invention minimizes image sticking to increase brightness, and reduces power consumption.

Meanwhile, the driving apparatus for a PDP according to the present invention would be structurally similar to the driving apparatus for existing PDPs; however, control over the operation timing of the switch devices is quite different than the operation of the switching devices in existing PDP devices. The operation timing of the switch devices is reflected in the circuit composition (i.e., design), such that the design causes at least a partial overlap of the rising voltage intervals and the falling voltage intervals of the sustain pulse SUSPY and the sustain pulse SUSPZ, as shown in FIG. 3 through FIG. 5.

As described above, the driving method of the plasma display device according to exemplary embodiments of the present invention causes at least a partial overlap of the sustain pulses applied to the scan electrode Y and the sustain electrode Z during the sustain period to generate the sustain discharge every rising voltage interval of the sustain pulses applied to the scan electrode Y and the sustain electrode Z. Accordingly, the present invention minimizes discharge delay time of the sustain discharge generated between the sustain pulses, to thereby minimize image sticking caused when a specific picture is implemented during a definite time (that is, when a still picture is displayed). Moreover, the present invention minimizes image sticking, to thereby increase brightness and reduce power consumption.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A plasma display device comprising:
a first driver configured such that it applies a first sustain pulse to a first electrode; and
a second driver configured such that it applies a second sustain pulse to a second electrode, wherein the second sustain pulse includes a rising voltage interval and the first sustain pulse includes a falling voltage interval, and wherein the rising voltage interval and the falling voltage interval at least partially overlap.

2. The plasma display device according to claim 1, wherein the second sustain pulse includes a falling voltage interval and the first sustain pulse includes a rising voltage interval, and wherein the falling voltage interval of the second sustain pulse and the rising voltage interval of the first sustain pulse at least partially overlap.

3. The plasma display device according to claim 2, wherein the rising voltage interval of the first sustain pulse and the falling voltage interval of the second sustain pulse at least partially overlap during a voltage variation interval, and wherein the duration of the voltage variation interval is about 10 ns to 500 ns.

4. The plasma display device according to claim 1, wherein the rising voltage interval of the second sustain pulse and the falling voltage interval of the first sustain pulse at least partially overlap during a voltage variation interval, and wherein the duration of the voltage variation interval is about 10 ns to 500 ns.

5. The plasma display device according to claim 1, wherein the duration of a voltage variation interval, defined by the beginning of the rising voltage interval of the second sustain pulse through the end of the falling voltage interval of the first sustain pulse, is less than one-third (⅓) the duration of a maintaining voltage interval of the second sustain pulse.

6. The plasma display device according to claim 1, wherein the duration of a voltage variation interval, defined by the beginning of the falling voltage interval of the second sustain pulse through the end of the rising voltage interval of the first sustain pulse, is less than one-third (⅓) the duration of a maintaining voltage interval of the first sustain pulse.

7. The plasma display device according to claim 1, wherein the rising voltage interval partially overlaps a maintaining interval associated with the first sustain pulse.

8. The plasma display device according to claim 1, wherein the falling voltage interval partially overlaps a maintaining interval associated with the second sustain pulse.

9. A plasma display device comprising:
a first driver configured such that it applies a first sustain pulse to a first electrode; and
a second driver configured such that it applies a second sustain pulse to a second electrode, wherein a duty cycle of the first sustain pulse and a duty cycle of the second sustain pulse have a range of 50% to about 67%, such that a rising voltage interval associated with the first sustain pulse overlaps a falling voltage interval associated with the second sustain pulse during at least a portion of a voltage variation interval.

10. The plasma display device according to claim 9, wherein the duration of the voltage variation interval is about 10 ns to 500 ns.

11. The plasma display device according to claim 9, wherein the duration of the voltage variation interval is less than one-third (⅓) the duration of a maintaining interval.

12. A method of driving a plasma display device comprising:
applying a first sustain pulse to a first electrode; and
applying a second sustain pulse to a second electrode, wherein the second sustain pulse includes a rising voltage interval and the first sustain pulse includes a falling voltage interval, and wherein the rising voltage interval and the falling voltage interval at least partially overlap.

13. The method according to claim 12, wherein the second sustain pulse includes a falling voltage interval and the first sustain pulse includes a rising voltage interval, and wherein the falling voltage interval of the second sustain pulse and the rising voltage interval of the first sustain pulse at least partially overlap.

14. The method according to claim 13, wherein the rising voltage interval of the first sustain pulse and the falling voltage interval of the second sustain pulse at least partially overlap during a voltage variation interval, and wherein the duration of the voltage variation interval is about 10 ns to 500 ns.

15. The method according to claim 12, wherein the rising voltage interval of the second sustain pulse and the falling voltage interval of the first sustain pulse at least partially overlap during a voltage variation interval, and wherein the duration of the voltage variation interval is about 10 ns to 500 ns

16. The method according to claim 12, wherein the first sustain pulse includes:
a rising voltage interval of about 300 ns to 700 ns;
a maintaining interval of about 1.7 μs to 1.9 μs; and
a falling voltage interval of about 300 ns to 600 ns.

17. The method according to claim 12, wherein the duration of a voltage variation interval, defined by the beginning of the rising voltage interval of the second sustain pulse through the end of the falling voltage interval of the first sustain pulse, is less than one-third (⅓) the duration of a maintaining voltage interval of the second sustain pulse.

18. The method according to claim 13, wherein the duration of a voltage variation interval, defined by the beginning of the falling voltage interval of the second sustain pulse through the end of the rising voltage interval of the first sustain pulse, is less than one-third (⅓) the duration of a maintaining voltage interval of the first sustain pulse.

19. The plasma display device according to claim 12, wherein the rising voltage interval partially overlaps a maintaining interval associated with the first sustain pulse.

20. The plasma display device according to claim 12, wherein the falling voltage interval partially overlaps a maintaining interval associated with the second sustain pulse.
